(19) United States
(12) Patent Application Publication
(10) Pub. No.: US 2004/0198357 A1
(43) Pub. Date: Oct. 7, 2004

(54) Method and apparatus for distinguishing priority service from eMLPP enhancement

(75) Inventors: Mark Plyle, Richardson, TX (US); Amarjit Deol, Plano, TX (US); Ricky Kaura, Middlesex (GB); Sandeep Patel, London (GB)

Correspondence Address: VERNON E. WILLIAMS P.C., P.O. BOX 941385, PLANO, TX, 75094, US

(73) Assignee: Nortel Networks Limited, St. Laurent (CA)

(21) Appl. No.: 10/814,359

(22) Filed: Mar. 31, 2004

Related U.S. Application Data
(60) Provisional application No. 60/459,452, filed on Apr. 1, 2003.
(60) Provisional application No. 60/480,436, filed on Jun. 23, 2003.

(51) Int. Cl. H04Q 7/20

(52) U.S. Cl. 455/435.3; 455/432.1

(57) ABSTRACT

The foregoing roaming scenarios are summarized in the Table given below. In accordance with the teachings of the present invention, a method and apparatus is presented for distinguishing between priority services. A new parameter is defined in an update location message. The new parameter enables an MSC/VLR to recognize and distinguish priority services. For example, the new parameter is used to distinguish eMLPP priority service from WPS priority service. In addition, the HLR will send a new parameter in the ISD message to distinguish which priority service subscription is applicable.

### CROSS REFERENCE TO RELATED APPLICATIONS

This is a utility application claiming priority of application Ser. No. 60/459,452 entitled “METHOD AND APPARATUS FOR DISTINGUISHING PRIORITY SERVICES FROM eMLPP ENHANCEMENT” filed on Apr. 1, 2003, the contents of which are incorporated herein by reference. This is a utility application claiming priority of application Ser. No. 60/480,436 entitled “METHOD AND APPARATUS FOR DISTINGUISHING PRIORITY SERVICES FROM eMLPP ENHANCEMENT” filed on Jun. 28, 2003, the contents of which are incorporated herein by reference.

### FIELD OF THE INVENTION

This invention relates to communication networks. Specifically, the present invention relates to wireless communication networks.

### DESCRIPTION OF THE PRIOR ART

In a conventional wireless network, a Mobile Station (MS) may be used by an end user to access network services. The MS includes interface equipment used to terminate a wireless radio path at the end-user side of a communication link. Examples of an MS include a cellular telephone, a wireless laptop, etc.

The MS communicates with a Base Station System (BSS). The BSS performs radio-related functions. In one embodiment, the BSS includes Base Transceiver Stations (BTSs) and a Base Station Controller (BSC). The BTS provides an interface to the MS. In one embodiment, the BTS includes radio equipment, such as the transceivers and antennas, needed to service each cell in a wireless network. Several BTSs are typically controlled by a BSC. The BSC provides control functions and physical links between a Message Switching Center (MSC) and the BTS. The MSC provides an interface to a Public-Switched Telephony Network (PSTN) or other MSCs. The MSC typically performs telephony switching functions.

In one embodiment, the MSC is in communication with a Visitor Location Register (VLR) or a VLR is deployed as part of the MSC. The VLR stores temporary information about visiting subscribers (i.e., subscribers who roam, etc.). The VLR communicates with a Home Location Register (HLR). The HLR stores permanent data about subscribers, including a subscriber's service profile, location information, activity, status, etc. When an MS roams into a new MSC area, the VLR in communication with that MSC will request data about the MS from the HLR associated with the MS. If the MS then operates to make a call, the VLR will have the information needed for call setup without having to interrogate the HLR.

During times of crises, the previously defined wireless network often suffers from network congestion and overload. For example, a large number of users would overload the wireless network during times of national emergency. As a result, network operators in the U.S. have deployed techniques for enabling emergency workers to request and access services from a wireless network. These techniques typically involve providing priority bandwidth to an end user when the end user attempts a call using a priority code.

In conventional wireless systems, priority services are provisioned with a Supplementary Service (SS) code as defined in TS 29.002 TS29.002 v3.11.0-3GPP Mobile Application Part (MAP) specification promulgated by the 3^{rd} Generation Partnership Project (3GPP). Priority-based services, such as Wireless Priority Service (WPS) and Enhanced Multi-Level Precedence and Pre-emption Service (eMLPP) are provisioned with an SS code. For example, in eMLPP the code is ‘10100001’B, which is the same code used for WPS. WPS is a subscription-based service that is based on the eMLPP service. Both WPS and eMLPP use the same SS code. When either WPS or eMLPP is deployed in a network, there is no conflict or problem distinguishing between the two services. However, when both priority services are offered in a network, there is no mechanism for distinguishing between WPS users and eMLPP users. In addition, over time priority services may be offered in a variety of different context and locations. Should the various priority services operate in the same network, there will be a need to distinguish from a variety of priority services that use the same SS code.

Thus, there is a need for a method and apparatus for distinguishing priority services. Further, there is a need for a method and apparatus for distinguishing between WPS and eMLPP services. Lastly, there is a need for a method and apparatus for distinguishing a variety of priority services that use the same supplementary code.

### SUMMARY OF THE INVENTION

The present invention is directed to a method and apparatus for distinguishing priority services that operate based on the same Supplementary Services (SS) code. In one embodiment, a single code is used to distinguish between multiple communications services. For example, a single supplementary services code is used to define multiple priority services. In another embodiment, multiple services are defined within the same supplementary code. For example, additional information, such as additional parameters, is provided in association with the supplementary code to distinguish between multiple services, such as multiple priority services.

It should be appreciated that the method and apparatus of the present invention extends beyond the supplementary services code and beyond priority services. In one embodiment, several new parameters are defined within a current messaging scheme to enable the identification and selection of a variety of services using a single code.

In one embodiment, a method and apparatus is presented for distinguishing priority services, such as WPS services and eMLPP services, using the same supplementary services (SS) code. In another embodiment, a method and apparatus is presented for distinguishing a multitude of priority services that use the same supplementary (SS) code. In another embodiment, a method and apparatus is presented for using a variety of supplementary services (SS) codes.

In one embodiment of the present invention, new parameters are defined and implemented in standardized protocols to enable an MSC/VLR to distinguish between different priority services. As such, the MSC/VLR may then distinguish a WPS service, an eMLPP service, a variety of other priority services, or a combination of priority services.

A method of operating comprises the steps of receiving a code; and distinguishing different telecommunication services in response to receiving the code.

A method of operating comprises the steps of generating a UL message including a priority services designation; receiving an ISD message in response to generating the UL message; generating an ISD-ack message in response to receiving the ISD message; and receiving a UL-ack message in response to generating the ISD-ack message.

A method of operating comprises the steps of receiving a UL message including a priority services designation; generating an ISD message in response to receiving the UL message; receiving an ISD-ack message in response to generating the ISD message; and generating a UL-ack message in response to receiving the ISD-ack message.

### BRIEF DESCRIPTION OF THE DRAWINGS

FIG. 1 displays a network implementing the teachings of the present invention.

FIG. 2 displays a block diagram of a computer implemented in accordance with the teachings of the present invention.

FIG. 3A displays a flow diagram depicting an embodiment of a method of distinguishing priority services in a network including a hybrid HLR.

FIG. 3B displays a flow diagram depicting an embodiment of method of distinguishing priority services in a network including a non-hybrid HLR.

FIG. 4 displays a message flow diagram depicting a scenario when an eMLPP subscriber roams into an eMLPP only network, when there is a non-hybrid HLR.

FIG. 5 displays a message flow diagram depicting a scenario when an eMLPP subscriber roams into a priority service only network, when there is a non-hybrid HLR.

FIG. 6 displays a message flow diagram depicting a scenario when an eMLPP subscriber roams into a hybrid network, when there is a non-hybrid HLR.

FIG. 7 displays a message flow diagram depicting a scenario when eMLPP subscriber roams into an eMLPP only network, when there is a hybrid HLR.

FIG. 8 displays a message flow diagram depicting a scenario when an eMLPP subscriber roams into a priority service only network, when there is a hybrid HLR.

FIG. 9 displays a message flow diagram depicting a scenario when an eMLPP subscriber roams into a hybrid network, when there is a hybrid HLR.

FIG. 10 displays a message flow diagram depicting a scenario when priority service subscriber roams into an eMLPP only network, when there is a hybrid HLR.

FIG. 11 displays a message flow diagram depicting a scenario when priority service subscriber roams into a priority service only network, when there is a hybrid HLR.

FIG. 12 displays a message flow diagram depicting a scenario when priority service subscriber roams into a hybrid network, when there is a hybrid HLR.

FIG. 13 a displays a message flow diagram depicting a scenario when priority service subscriber roams into a priority service network, that does not support the required priority service level.

FIG. 14 a displays a message flow diagram depicting a scenario when priority service subscriber roams into a hybrid network that does not support the required priority service level.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

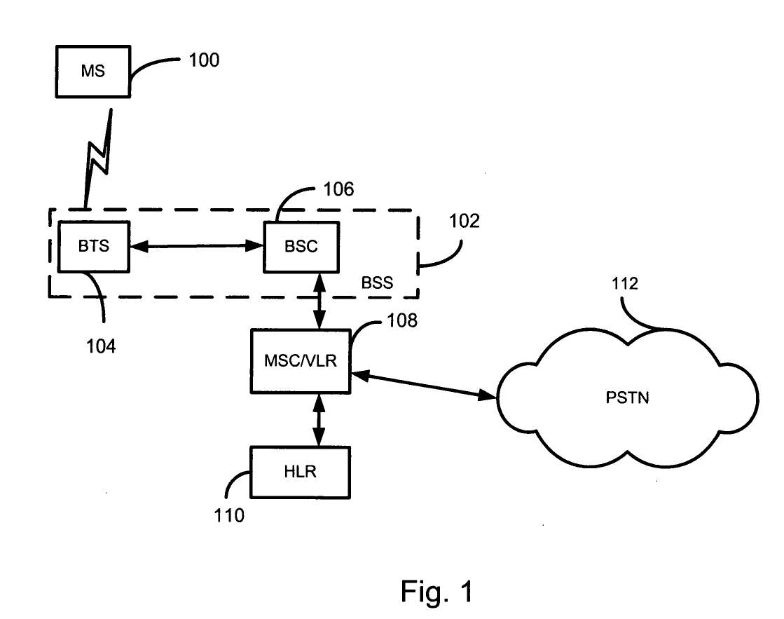

FIG. 1 displays an architecture implementing the method of the present invention. In FIG. 1 a mobile station (MS) 100 communicates with a BSS 102. In one embodiment, the BSS 102 includes a BTS 104 and a BCS 106. The BSC 106 communicates with an MSC/VLR 108. The MSC/VLR 108 accesses subscription information from an HLR 110. The MSC/VLR 108 also communicates with a network such as the PSTN 112.

It should be appreciated that a variety of alternative configurations may be implemented and still remain within the scope of the present invention. For example, the VLR may be deployed separately from the MSC. The HLR 110 may be deployed as part of the MSC/VLR 108. Further the HLR 110 may communicate directly with the MSC/VLR 108 as shown or the HLR 110 may communicate across a network such as the PSTN 112 with the MSC/VLR 108.

Throughout the disclosure a variety of terms will be used. A code may be defined as any symbol or group of symbols used to identify a communications service. In one embodiment, a code is implemented using a supplementary services code. In one embodiment, a priority service may be defined as any service, such as a subscription service that enables an end-user to gain priority bandwidth in a network. For example, a subscription service that enables an end user to be given a priority during an emergency would be considered a priority service. In a second embodiment, a priority service is defined as a service that includes eMLPP, an eMLPP based service such as WPS or other services that are based on eMLPP. In a third embodiment, the WPS service and the eMLPP service are specific priority services that are recited and discussed, however a variety of priority services may be implemented and still remain within the scope of the present invention.

Throughout the disclosure devices and/or services may be described as “hybrid” devices and/or services. A hybrid device and/or service is one that operates or includes more than one priority service. For example, a hybrid HLR stores subscription information on both WPS and eMLPP priority services. It should also be appreciated that the term “hybrid” may also be used to include additional priority services (i.e., a multitude and/or variety of priority services). A device or service may also be defined as a “non-hybrid” device. For example, a non-hybrid HLR may be implemented. “Non-hybrid” refers to a device and/or service that processes one service or another. For example, a non-hybrid defines an HLR that stores subscription information related to WPS or eMLPP. As such the HLR may be described as non-hybrid, hybrid, etc. These designations refer to an HLR that stores subscriber information for an MS operated by an end user that has subscribed to non-hybrid, hybrid, etc, priority service. It should be appreciated that when multiple priority services are implemented that the “hybrid” designation would refer to all of the services and a “non-hybrid” designation would refer to one of the services

Devices may be described as having a capability. For example, an MS may be defined has having eMLPP capability, WPS capability, etc. The MS capability is refers to an end-user who has subscribed to eMLPP service, WPS service, hybrid service, etc and is operating the MS. Therefore, the MS may receive eMLPP information, WPS information, hybrid information, etc, since the end-user has subscribed to these priority services.

During operations, an end user operates the MS 100. Operating the MS 100 may include turning on the MS 100, attempting to make a call with the MS 100, etc. A signal is transmitted through the BSS 102 to the MSC/VLR 108. If the end user is a visitor the HLR 110 is accessed and the MSC/VLR 108 is updated. If the end user is not a visitor the MSC/VLR 108 accesses the HLR 110. The HLR 110 communicates subscription information to the MSC/VLR 108. The subscription information provides information on the calling services that an end user operating the MS 100 has subscribed to such as call waiting, call forwarding, priority services, etc. If the MSC/VLR 108 has the capability to provide the calling services, the MSC/VLR 108 is then able to provide the calling services to the MS 100.

In one embodiment of the present invention, priority services are implemented and distinguished. Information and signaling is communicated between the MSC/VLR 100 and the HLR 110 to facilitate the priority services. For example, in one embodiment, methods are implemented in the MSC/VLR 108 to enable the MSC/VLR 108 to distinguish between various types of priority services. In a second embodiment, methods are implemented in the MSC individually to enable the MSC to distinguish between various types of priority services. In a fourth embodiment, methods are implemented in the VLR individually to enable the VLR to distinguish between various types of priority services. In a fifth embodiment, methods are implemented in the HLR 110 to enable the HLR 110 to distinguish between various types of priority services. In a sixth embodiment, methods are implemented in accordance with the teachings of the present invention to enable any permutation or combination of an MSC, VLR and/or HLR to distinguish between various types or priority services.

In one embodiment, various messages are defined in accordance with TS29.002 v3.11.0-3GPP Mobile Application Part (MAP) specification promulgated by the 3^{rd} Generation Partnership Project (3GPP). In accordance with the teachings of the present invention, the MAP Update Location Message (UL), the EMLPP-Info parameter in the MAP Insert Subscriber Data (ISD) message, the MAP ISD-ack message and the MAP UL-ack message are utilized.

In accordance with one embodiment of the present invention, the UL message is communicated from the MSC/VLR 108 to the HLR 110. The MAP UL message as defined in TS29.002 is used by the VLR to update the location information stored in the HLR. In accordance with one embodiment of the present invention, an ISD message is communicated from the HLR 110 to the MSC/VLR 108. The MAP ISD message is defined in TS29.002 as a message used by the HLR to update the VLR with subscriber data. In accordance with one embodiment of the present invention, an ISD-ack message is communicated from the MSC/VLR 108 to the HLR 110. The MAP ISD-ack message is defined in TS29.002 as an acknowledgement to the MAP ISD message. In accordance with one embodiment of the present invention, a UL-ack message is communicated from the HLR 110 to the MSC/VLR 108. The MAP UL-ack message is defined in TS29.002 as an acknowledgement to the MAP UL message. In accordance with the teachings of the present invention, a new priorityservice-capability parameter is defined in the update location (UL) message. In one embodiment of the present invention, the new priority service-capability parameter defined in the UL is implemented to distinguish priority services. In addition the eMLPP-lnfo parameter in the Insert Subscriber Data (ISD) message is utilized.

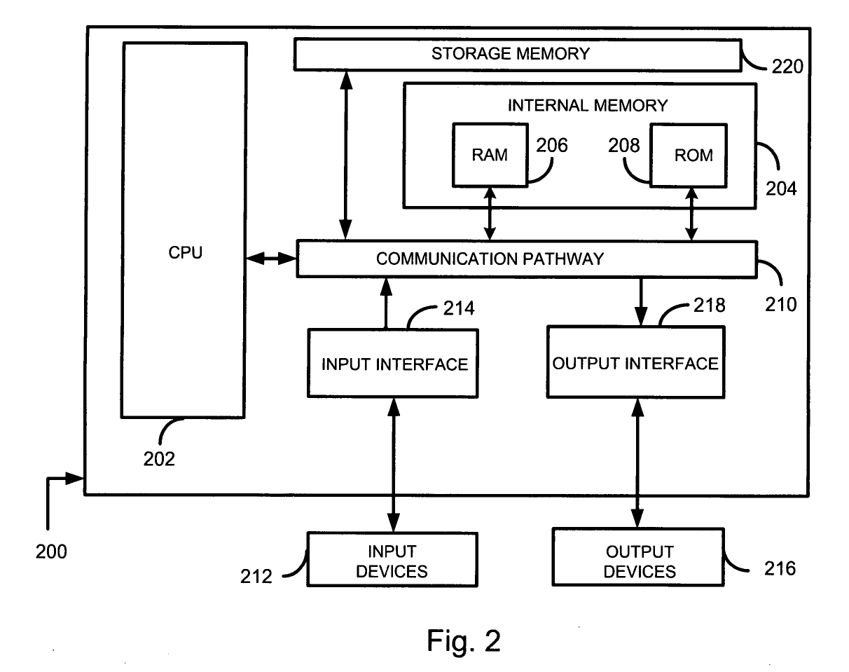

FIG. 2 displays a computer architecture that may be used to implement the MS 100, the BSS 102, the MSC/VLR 108, the VLR 109, the HLR 110 and the PSTN 112 of FIG. 1. A central processing unit (CPU) 202 functions as the brain of the computer 200. Internal memory 204 is shown. The internal memory 204 includes short-term memory 206 and long-term memory 208. The short-term memory 206 may be a Random Access Memory (RAM) or a memory cache used for staging information. The long-term memory 208 may be a Read Only Memory (ROM) or an alternative form of memory used for storing information. Storage memory 220 may be any memory residing within the computer 200 other than internal memory 204. In one embodiment of the present invention, storage memory 220 is implemented with a hard drive. A communication pathway 210 is used to communicate information within computer architecture 200. In addition, the communication pathway 210 may be connected to interfaces, which communicate information out of the computer 200 or receive information into the computer 200.

Input devices, such as a tactile input device, keyboard, communications connections are shown as 212. The input devices 212 interface with the system through an input interface 214. Output devices, such as a monitor, communications connection, etc, are shown as 216. The output device 216 communicate with computer 200 through an output interface 218.

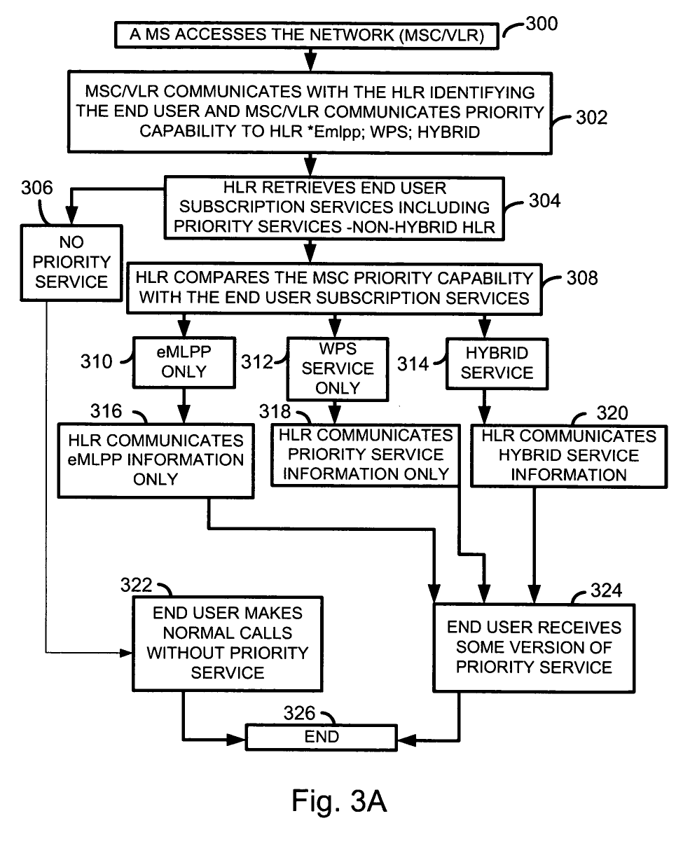

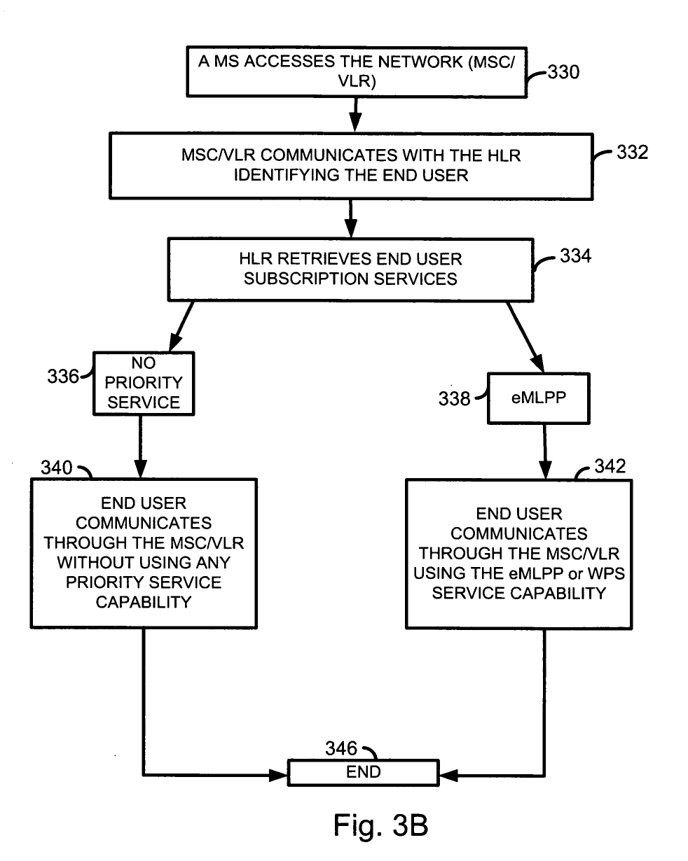

FIG. 3A displays a flow diagram depicting an embodiment of a method of distinguishing priority services in a network including a hybrid HLR. FIG. 1 will be discussed in conjunction with FIG. 3A. At step 300, the MS accesses the network (i.e., MSC/VLR 108). At step 302 the MSC/VLR 108 communicates with the HLR identifying the end-user (i.e., operating the MS) and the MSC/VLR communicates priority capability information to the HLR 110. The priority capability information defines the priority services that the MSC/VLR 108 can support. For example, the priority capability information may include eMLPP information, WPS information, hybrid information, etc.

In one embodiment the MSC/VLR 108 is enhanced to identify the new priorityservice-capability parameter in the UL message. The priorityservice-capability parameter is used by the MSC/VLR 108 to identify a priority service. As defined previously, the term priority service will be used when WPS service, eMLPP service or hybrid service is deployed. The term hybrid service will be used when both WPS and eMLPP are deployed. The term non-hybrid service will be used when either WPS service or eMLPP service is deployed.

Table 1 provided below details the Update Location (UL) message. For example, the UL message is shown as the “VLR-Capability.” The UL message is consistent with TS29.002 V3.11.0-3GPP Mobile Application Part (MAP) specification promulgated by the 3^{rd} Generation Partnership Project (3GPP) and is written in ASN.1. In Table 1 the “priority service-capability” parameter is shown as part of the UL message. In addition, the “supportedpriorityservices” may be defined and implemented to support a variety of priority services.

TABLE 1
VLR-Capability ::= SEQUENCE{

| | | |
|---|---|---|
| supportedCamelPhases | [0] SupportedCamelPhases | OPTIONAL, |
| extensionContainer | ExtensionContainer | OPTIONAL, |
| ... , | | |
| solsaSupportIndicator | [2] NULL | OPTIONAL, |
| istSupportIndicator | [1] IST-SupportIndicator | OPTIONAL, |

superChargerSupportedInServingNetworkEntity

| | [3] SuperChargerlnfo | | OPTIONAL, |
|---|---|---|---|
| longFTN-Supported | [4] | NULL | OPTIONAL, |
| supportedLCS- | [5] | SupportedLCS- | |

| | |
|---|---|
| Capability Sets | CapabilitySets |
| OPTIONAL, | |

| | | |
|---|---|---|
| priorityservice-capability | [6] | OPTIONAL, |
| supportedpriorityservices | [7] supportedpriorityservices, | OPTIONAL} |

Table 2 given below details one embodiment of the “supportpriorityservices” parameter. The “supportpriorityservices” parameter may be implemented to support a wide range of priority services. As detailed below, a “northamericanpriorityservice” parameter is presented and a “chinapriorityservice” parameter is presented. However, it should be appreciated that a range of priority services may be implemented. In addition, in one embodiment, if no bit is set in the “supportpriorityservices” parameter then the sending node does not support a priority service.

TABLE 2

supportedpriorityservices ::= {
NorthAmericanPriorityService (1),
ChinaPriorityService (2) } BIT STRING (SIZE (2..64))

In one embodiment, MSC/VLR's that support either the priority service or the hybrid service are enhanced to support a PrioritySubscription field in the eMLPP-Info parameter in the Insert Subscriber Data (ISD) message. In one embodiment, eMLPP only networks and/or networks that don't support eMLPP do not need to upgrade/change to support the new PrioritySubscription parameter in the ISD message as the HLR will not send them priority service subscription information, due to the absence of the priorityService-capability in the UL message. Table 3 given below details the eMLPP-Info parameter in the Insert Subscriber Data (ISD) message.

TABLE 3
EMLPP-Info ::= SEQUENCE {

| | |
|---|---|
| maximumentitledPriority | EMLPP-Priority, |
| defaultPriority | EMLPP-Priority, |

| | |
|---|---|
| extensionContainer | ExtensionContainer OPTIONAL, |
| ... , | |
| PrioritySubscription | PrioritySubscription OPTIONAL} |

Table 4 given below details the new PrioritySubscription parameter defined in the EMLPP-info parameter.

TABLE 4

PrioritySubscription ::= INTEGER(1..64)

Examples:
-- value 1 = North America Priority Service,
-- value 2 = China Priority Service:

The range of numbers (i.e., 1 . . . 64) is proposed in anticipation of future offerings of priority service (i.e., North America Priority Service, China Priority Service, etc.).

At step 304, the HLR 110 retrieves the end user subscription information, including priority service subscription information. In one embodiment, the priority service subscription information that is stored in the HLR 110 is transferred to the MSC/VLR 108 in a MAP INSERT_SUBSCRIBER_DATA message during Location Update. At step 306, if the end user has not subscribed to any priority service, the end user communicates through the MSC/VLR 108 without using priority service capability. MSC/VLRs 108 that do not support either priority service (i.e., WPS, eMLPP) may operate without being required to make any changes.

At step 308, if the end user subscribes to the priority service, the HLR 110 compares the MSC/VLR 108 priority capability information with the end user subscription services information. At steps 310, 312 and 314, the HLR 110 communicates priority service information back to the MSC/VLR 108. For example, when eMLPP 310 is supported eMLPP information is communicated. When WPS 312 information is supported WPS information is communicated. When hybrid service 314 is supported, hybrid information is communicated. In one embodiment, when the MSC/VLR 108 does support priority service the priority service information communicated from the HLR 110 to the MSC/VLR 108 includes maximum priority information and default priority information. The maximum priority information includes information that defines the highest priority for an end-user. The default priority information includes information that defines the default priority for an end-user.

Table 5 given below details one embodiment of a priority service level mapping. In Table 5 WPS priority information is provided in column I, eMLPP priority information is provided in column II and the GSM 08.08 priority levels as defined by TS 08.08 v8. 12.0—3GPP Mobile-services switching center—Base Station System (MSC-BSS) interface specification, is detailed in column III. As an example, using Table 5, a WPS priority service user (1) with Emlpp priority level (B) would be data-filled in the HLR 110 as: Max priority=b, Default priority=4. A WPS PRIORITY SERVCE USER (2) WITH EMLPP PRIORITY LEVEL (0) WOULD BE DATA data-filled in the HLR 110 as: Max priority=0, Default priority=4.

In one embodiment, priority information detailing both the maximum and the default priority levels sent from HLR 110 to the MSC/VLR 108 are stored in MSC/VLR 108. However, it should be appreciated that this priority level information may be stored in various locations and still remain within the scope of the present invention. The MSC/VLR 108 maps the eMLPP priority level to 08.08 priority level and sends this to the BSS 102.

TABLE 5

| | | eMLPP | | |
|---|---|---|---|---|
| WPS Priority | | Priority | | |
| Service Priority | | Levels (in | | |
| Levels | | HLR) | 08.08 Priority Levels | |
| | | A | 1 | (used for Service Technicians) |
| 1 | (highest) | B | 2 | (used for Priority Service in US) |
| 2 | | 0 | 3 | (used for Priority Service in US) |
| 3 | | 1 | 4 | (used for Priority Service in US) |
| 4 | | 2 | 5 | (used for Priority Service in US) |
| 5 | (lowest, | 3 | 6 | (used for Priority Service in US) |
| | default) | | | |
| | | 4 | 7 | (used for emergency calls in US) |
| | | | 8 | |
| | | | 9 | |
| | | | 10 | |
| | | | 11 | |
| | | | 12 | |
| | | | 13 | |
| | | | 14 | (used for normal call in US |
| | | | | Priority Service) |

At step 310 of FIG. 3A, if the MSC/VLR 108 supports eMLPP and the end user has eMLPP service, then at step 316, the HLR 110 communicates priority information (i.e., eMLPP information). In an alternative embodiment, if the either the MS 100 or the MSC/VLR 108 does not support eMLPP service, then priority information would not be communicated. At step 312, if the MSC/VLR 108 supports WPS service and the end user subscribes to WPS service, then at step 318, the HLR 110 communicates WPS service information. In an alternative embodiment, if the either the MS 100 or the MSC/VLR 108 does not support WPS service, then WPS service information would not be communicated.

At step 314, if the MSC/VLR 108 supports a hybrid service and the end user has hybrid service, then at step 320, the HLR 110 communicates hybrid information. In an alternative embodiment, if either the MS 100 associated with an end user or the MSC/VLR 108 does not support hybrid service, then no priority service information will be communicated.

In one embodiment, when the MSC/VLR108 is operating in hybrid mode (i.e., supporting both services), the MSC/VLR 108 maps eMLPP priorities B-4 to 08.08 priorities 8-13 respectively as shown in Table 6 given below.

TABLE 6

| EMLPP | | |
|---|---|---|
| Priority | | |
| Levels (in | | |
| HLR) | 08.08 Priority Levels | |
| A | 1 | (used for Service |
| | | Technicians) |
| B | 8 | (used for Service |
| | | Technicians) |
| 0 | 9 | |
| 1 | 10 | |
| 2 | 11 | |
| 3 | 12 | |
| 4 | 13 | |

The foregoing roaming scenarios are summarized in the Table given below. At step 324, once the eMLPP, the WPS or the hybrid service information is communicated, the MS 100 may communicate through the MSC/VLR 108 using the priority service capability of the MSC/VLR 108. At step 326, the process ends.

In addition to the scenario where there may be a one-to-one correspondence between the MSC/VLR capability and the priority service capability of an MS (i.e., subscriber service as stored in the HLR), a variety of scenarios may occur as an MS roams. For example:

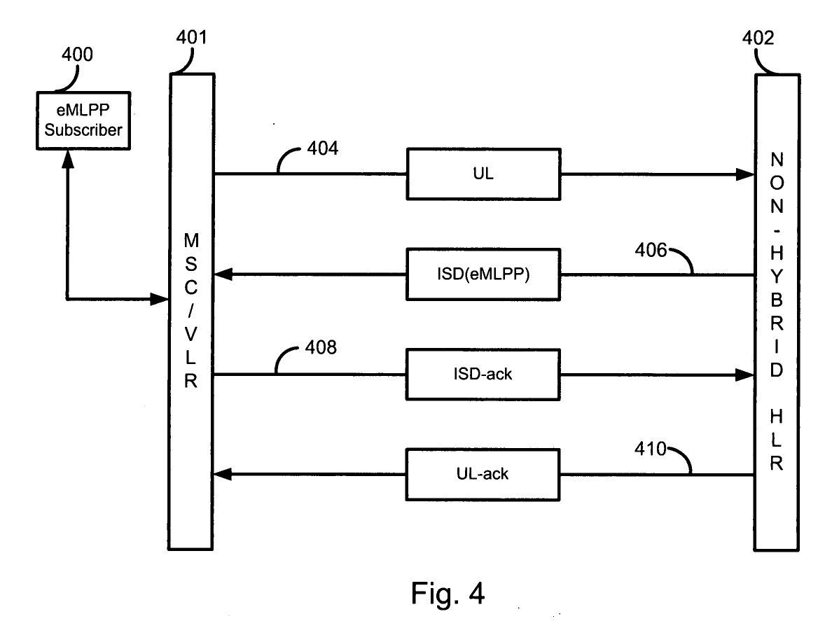

(1) an eMLPP subscriber may roam to an eMLPP only network, when there is a non-hybrid HLR implemented—FIG. 4;

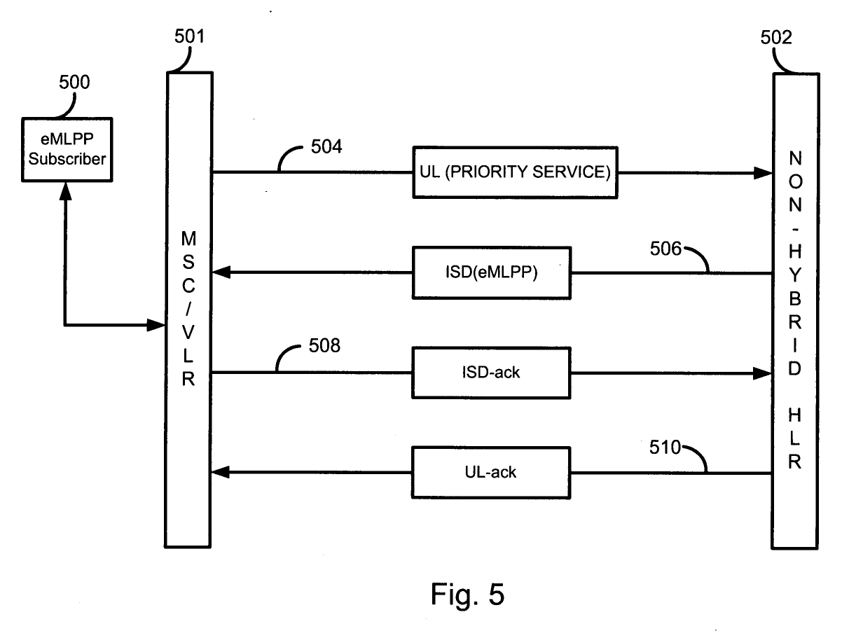

(2) an eMLPP subscriber may roam to a priority service only network, when there is a non-hybrid HLR implemented—FIG. 5;

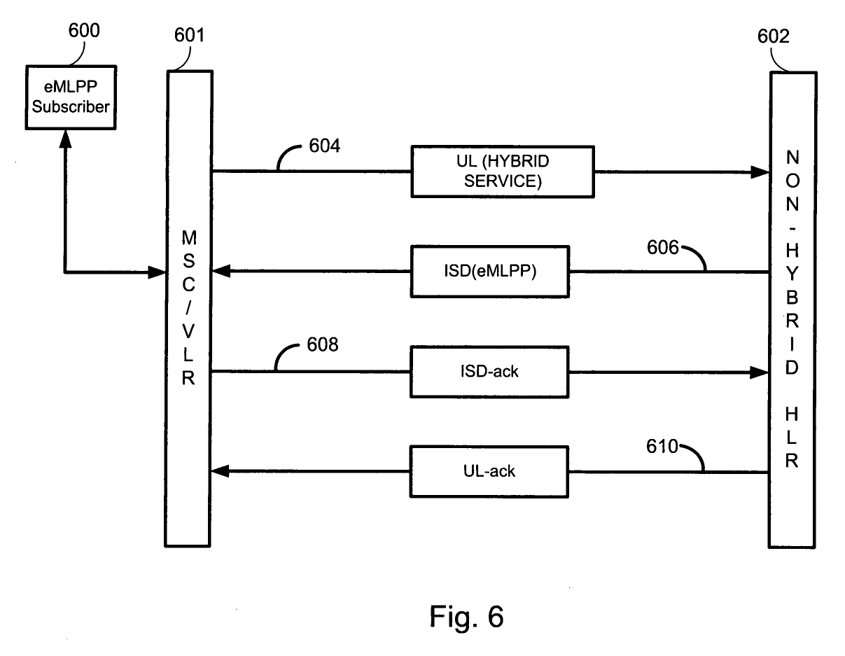

(3) an eMLPP subscriber may roam to a hybrid network, when there is a non-hybrid HLR implemented—FIG. 6;

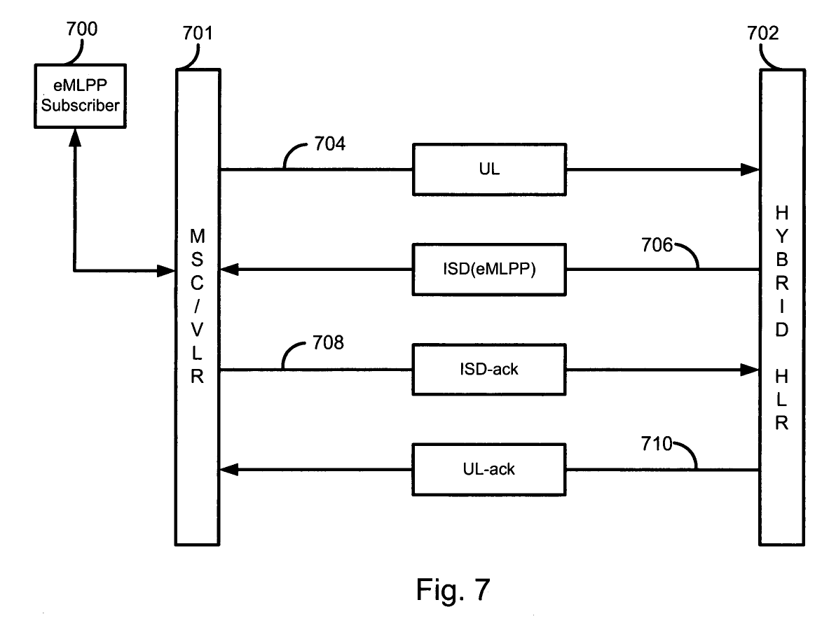

(4) an eMLPP subscriber may roam to an eMLPP only network, when there is a hybrid HLR implemented—FIG. 7;

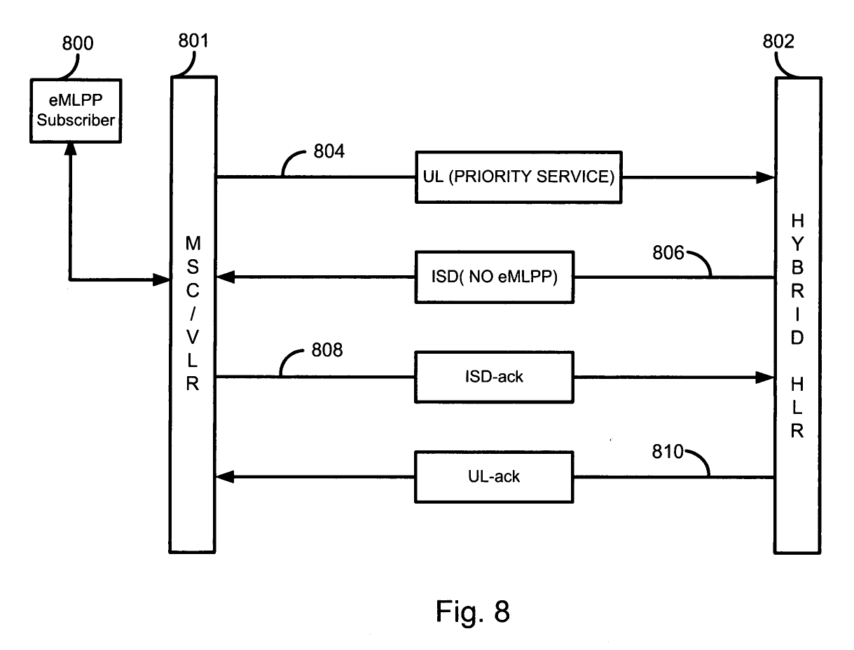

(5) an eMLPP subscriber may roam to a priority service only network, when there is a hybrid HLR implemented—FIG. 8;

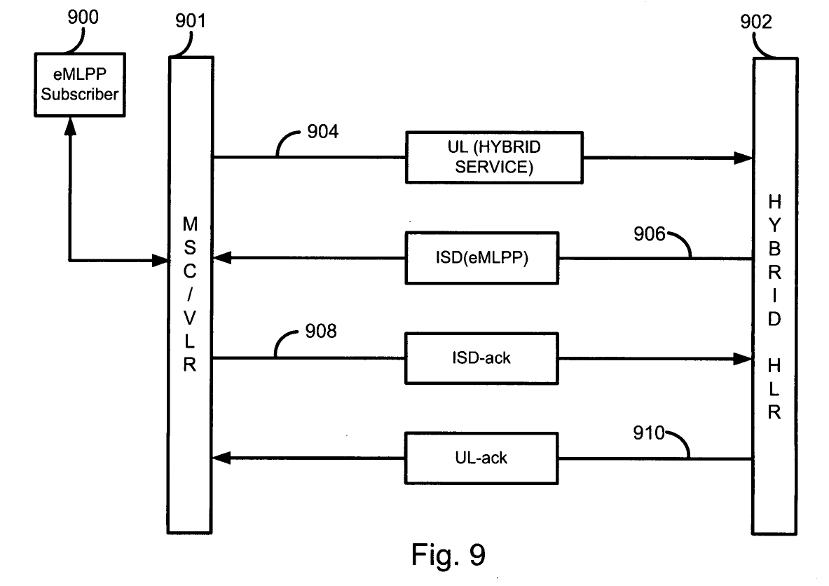

(6) an eMLPP subscriber may roam to a hybrid network, when there is a hybrid HLR implemented—FIG. 9;

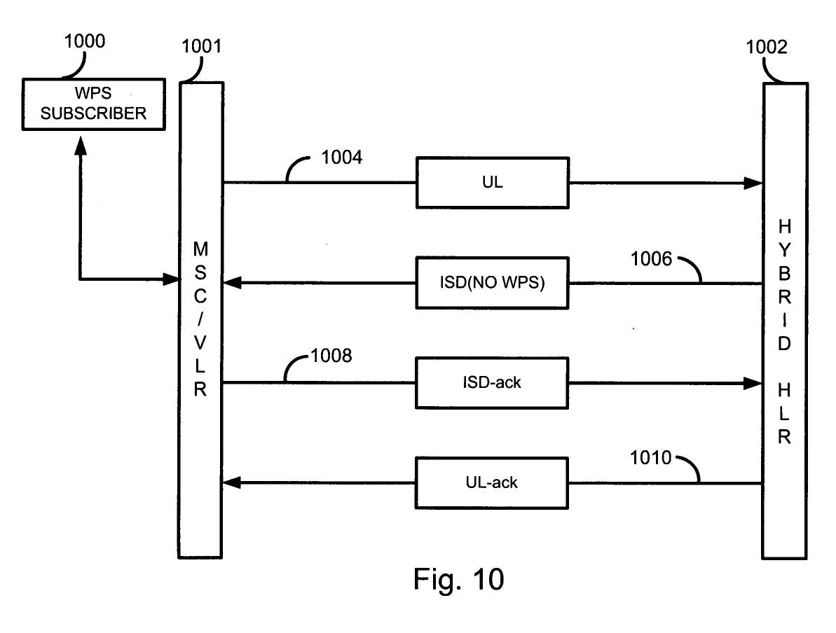

(7) a priority service subscriber may roam to an eMLPP only network, when there is a hybrid HLR implemented—FIG. 10;

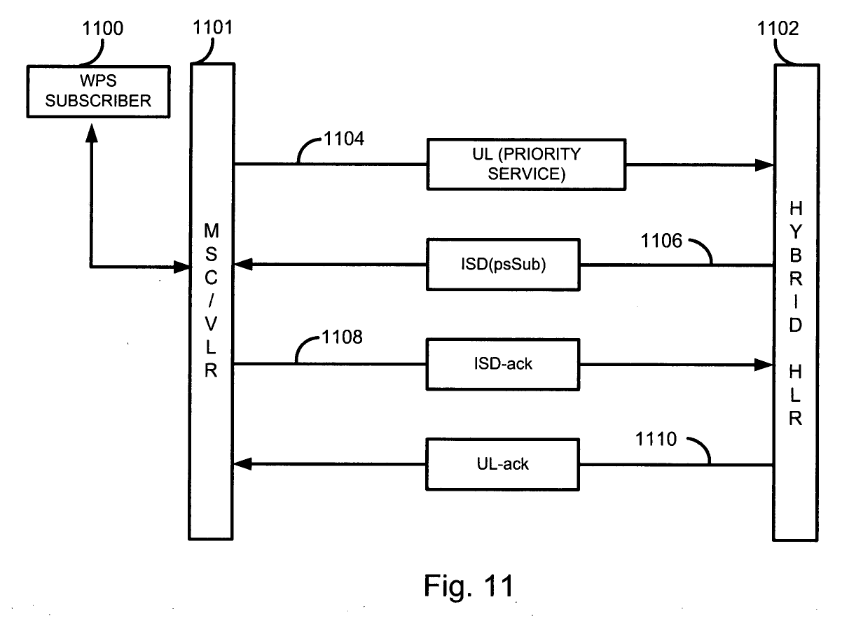

(8) a priority service subscriber may roam to a priority service only network, when there is a hybrid HLR implemented—FIG. 11;

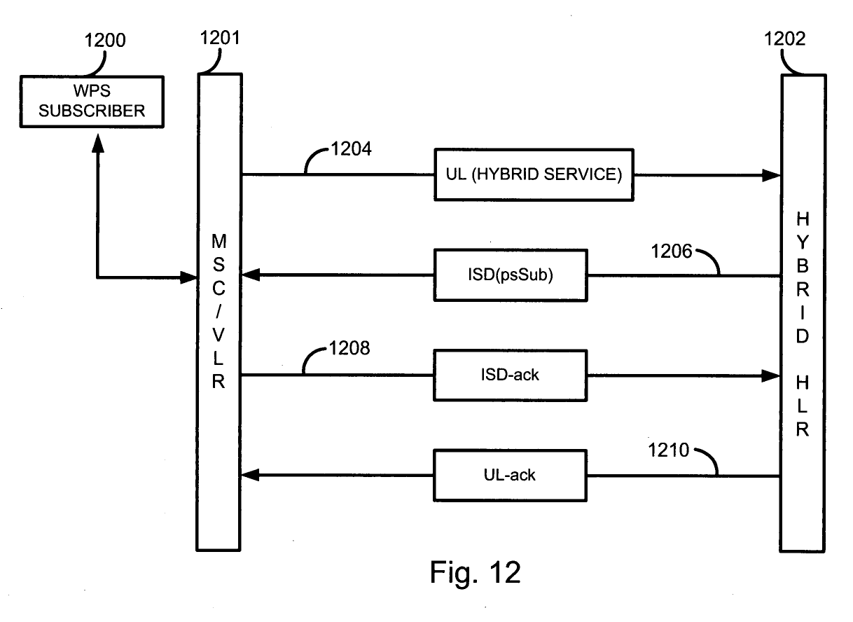

(9) a priority service subscriber may roam to a hybrid network, when there is a hybrid HLR implemented—FIG. 12;

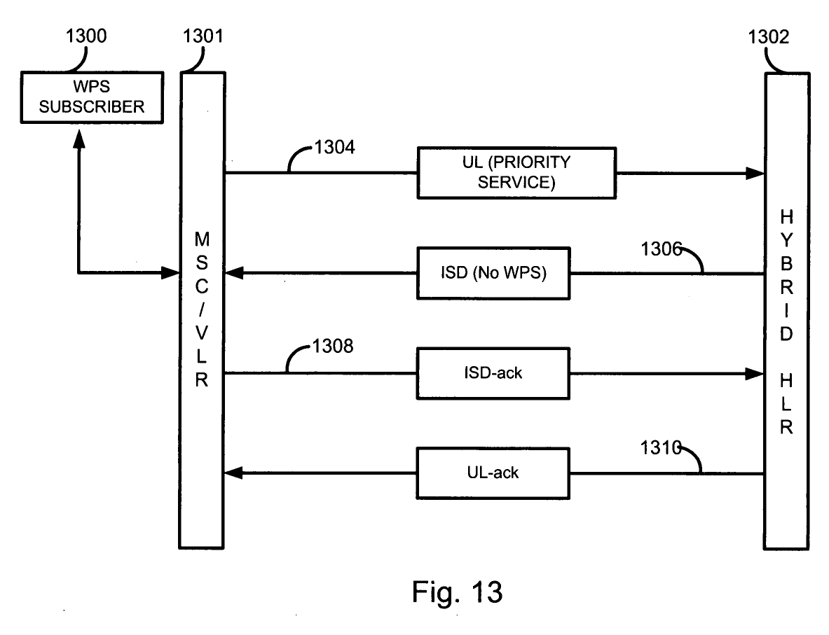

(10) a priority service subscriber may roam to a priority service network, that does not support the required priority service type/level implemented—FIG. 13;

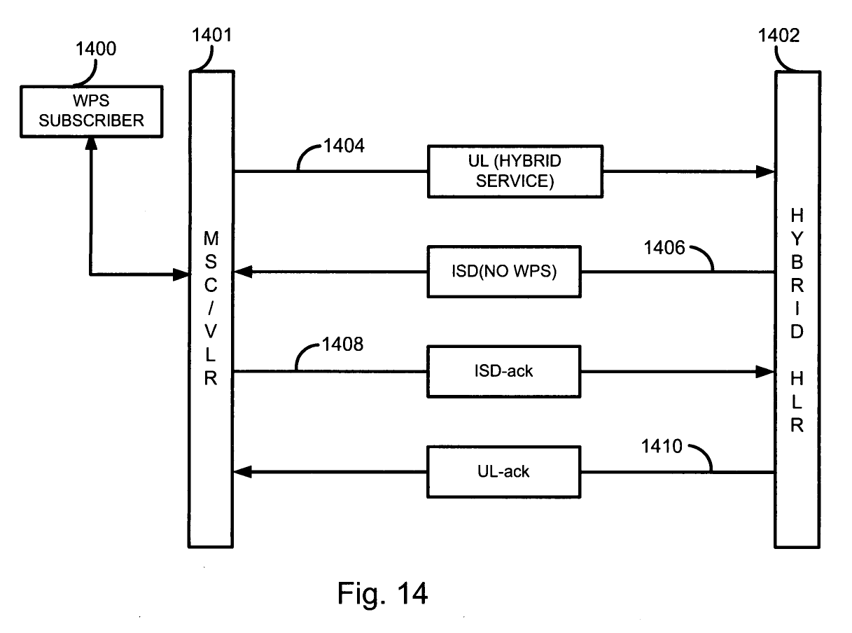

(11) a priority service subscriber may roam to a hybrid network that does not support the required priority service type/level implemented—FIG. 14.

FIG. 4 displays a message flow diagram depicting a scenario when an eMLPP subscriber 400 roams into an eMLPP network. In FIG. 4 a MSC/VLR 401 communicates with a non-hybrid HLR 402. In one embodiment, the non-hybrid HLR 402 represents an HLR storing subscriber information for an end user that has subscribed to eMLPP priority service. In the scenario when an eMLPP subscriber 400 roams into an eMLPP network the MSC/VLR 401 communicates a UL message 404 to the non-hybrid HLR 402. An ISD message 406 designating eMLPP is communicated from the non-hybrid HLR 402 to the MSC/VLR 401. The MSC/VLR 401 responds with an ISD-ack message 408. The non-hybrid HLR responds with a UL-ack message 410.

FIG. 5 displays a message flow diagram depicting a scenario when an eMLPP subscriber 500 roams into a priority service only network. In FIG. 5 an MSC/VLR is depicted as 501. The MSC/VLR 501 communicates with a non-hybrid HLR 502. In one embodiment, the non-hybrid HLR represents an HLR storing subscriber information for an end user that has subscribed to eMLPP only. In the scenario when an eMLPP subscriber roams into a priority service (WPS) only network the MSC/VLR 501 communicates a UL 504 specifying priority service (WPS) to the non-hybrid HLR 502. An ISD message 506 designating eMLPP is communicated from the non-hybrid HLR 502 to the MSC/VLR 501. The MSC/VLR 501 responds with an ISD-ack message 508. The non-hybrid HLR 502 responds with a UL-ack message 510.

In one embodiment of the present invention, the MSC/VLR 501 indicates that it is a priority service MSC/VLR 501 only. The non-hybrid HLR 502 is not a hybrid HLR and so does not understand (i.e., interpret) the PrioritySubscription field (i.e., Table 4) in the UL. The non-hybrid HLR 502 incorrectly sends eMLPP information to the MSC/VLR 501. The MSC/VLR 501 does not interpret the PrioritySubscription parameter and hence determines that the data is not priority service and alerts the non-hybrid HLR 502 that eMLPP is not supported by returning the SS code for eMLPP back in the ISD-ack message 508.

FIG. 6 displays a message flow diagram depicting a scenario when an eMLPP subscriber roams into a hybrid network. In FIG. 6 an MSC/VLR is depicted as 601. The MSC/VLR 601 communicates with a non-hybrid HLR 602. In one embodiment, the non-hybrid HLR represents an HLR storing subscriber information for an end user that has subscribed to a hybrid service. In the scenario when an eMLPP subscriber roams into a hybrid network the MSC/VLR 601 communicates a UL 604 specifying hybrid service to the non-hybrid HLR 602. An ISD message 606 designating eMLPP is communicated from the non-hybrid HLR 602 to the MSC/VLR 601. The MSC/VLR 601 responds with an ISD-ack message 608. The non-hybrid HLR 602 responds with a UL-ack message 610.

The MSC/VLR 601 indicates that it supports the hybrid service in the UL message 604 along with the level and/or type of priority service supported. The non-hybrid HLR 602 is not a hybrid HLR and so does not interpret the hybrid & PrioritySubscription parameter (i.e., Table 4) in the UL message 604. The non-hybrid HLR 602 sends eMLPP data to the MSC/VLR 600 that treats the data as eMLPP as there is no PrioritySubscription parameter included.

FIG. 7 displays a message flow diagram depicting a scenario when an eMLPP subscriber roams into an eMLPP only network, with a hybrid HLR. In FIG. 7 an MSC/VLR is depicted as 701. The MSC/VLR 701 communicates with a hybrid HLR 702. In one embodiment, the hybrid HLR represents an HLR storing subscriber information for an end user that has subscribed to eMLPP priority service. In the scenario when an eMLPP subscriber roams into an eMLPP only network implemented with a hybrid HLR 702 the MSC/VLR 701 communicates a UL 704 to the hybrid HLR 702. An ISD message 706 designating eMLPP is communicated from the hybrid HLR 702 to the MSC/VLR 701. The MSC/VLR responds with an ISD-ack message 708. The hybrid HLR responds with a UL-ack message 710.

FIG. 8 displays a message flow diagram depicting a scenario when an eMLPP subscriber roams into a priority service (WPS) only network, with a hybrid HLR. In FIG. 8 an MSC/VLR is depicted as 801. The MSC/VLR 801 communicates with a hybrid HLR 802. In one embodiment, the hybrid HLR 802 represents an HLR storing subscriber information for an end user that has subscribed to WPS priority service. In the scenario when an eMLPP subscriber roams into a priority service (WPS) only network implemented with a hybrid HLR 802 the MSC/VLR 801 communicates a UL 804 with priority service (WPS) designated to the hybrid HLR 802. An ISD message 806 designating eMLPP is communicated from the hybrid HLR 802 to the MSC/VLR 801. The MSC/VLR 801 responds with an ISD-ack message 808. The hybrid HLR 802 responds with a UL-ack message 810. The MSC/VLR 801 indicates that it supports Priority Service (WPS) only and hence the hybrid HLR 802 does not send the eMLPP subscription information to it. The subscriber is treated as a normal subscriber.

FIG. 9 displays a message flow diagram depicting a scenario when an eMLPP subscriber roams into a hybrid network, with a hybrid HLR. In FIG. 9 an MSC/VLR is depicted as 901. The MSC/VLR 901 communicates with a hybrid HLR 902. In one embodiment, the hybrid HLR 902 represents an HLR storing subscriber information for an end user that has subscribed to a hybrid service. In the scenario when an eMLPP subscriber roams into a hybrid network implemented with a hybrid HLR 902 the MSC/VLR 901 communicates a UL 904 with hybrid service designated to the hybrid HLR 902. An ISD message 906 designating eMLPP is communicated from the hybrid HLR 902 to the MSC/VLR 901. The MSC/VLR 900 responds with an ISD-ack messge 908. The hybrid HLR 902 responds with a UL-ack message 910. The MSC/VLR 901 indicates that it supports the hybrid service in the UL 904. The HLR responds by sending eMLPP data in the ISD message 908.

FIG. 10 displays a message flow diagram depicting a scenario when a WPS subscriber roams into an eMLPP network, implemented with a hybrid HLR. In FIG. 10 an MSC/VLR is depicted as 1001. The MSC/VLR 1001 communicates with a hybrid HLR 1002. In one embodiment, the hybrid HLR 1002 represents an HLR storing subscriber information for an end user that has subscribed to a WPS priority service. In the scenario when an WPS service subscriber roams into a eMLPP only network implemented with a hybrid HLR 1002 the MSC/VLR 1001 communicates a UL message 1004 to the hybrid HLR 1002. An ISD message 1006 designating no WPS information is communicated from the hybrid HLR 1002 to the MSC/VLR 1001. The MSC/VLR 1001 responds with an ISD-ack messge 1008. The hybrid HLR 1002 responds with a UL-ack message 1010. The MSC/VLR 1001 does not indicate that it supports the WPS service and hence the HLR does not send the WPS service profile to the MSC/VLR 1001. The WPS subscriber 1001 is treated as a normal subscriber.

FIG. 11 displays a message flow diagram depicting a scenario when a WPS service subscriber roams into a priority service only network, implemented with a hybrid HLR. In FIG. 11 an MSC/VLR is depicted as 1101. The MSC/VLR 1101 communicates with a hybrid HLR 1102. In one embodiment, the hybrid HLR 1102 represents an HLR storing subscriber information for an end user that has subscribed to a WPS priority service. In the scenario when an WPS service subscriber roams into a WPS priority only network implemented with a hybrid HLR 1102 the MSC/VLR 1101 communicates a UL message 1104 designating priority service (WPS) to the hybrid HLR 1102. An ISD message 1106 designating the pspublication parameter is communicated from the hybrid HLR 1102 to the MSC/VLR 1101. The MSC/VLR 1101 responds with an ISD-ack messge 1108. The hybrid HLR 1102 responds with a UL-ack message 1110. The MSC/VLR 1101 indicates that it supports Priority Service. The HLR responds by sending priority service data (inc. PrioritySubscription parameter) in the ISD. Note that the PrioritySubscription parameter is required here to differentiate between different variants of Priority Service.

FIG. 12 displays a message flow diagram depicting a scenario when a WPS subscriber 1200 roams into a hybrid network, implemented with a hybrid HLR. In FIG. 12 an MSC/VLR is depicted as 1201. The MSC/VLR 1201 communicates with a hybrid HLR 1202. In one embodiment, the hybrid HLR 1202 represents an HLR storing subscriber information for an end user that has subscribed to a hybrid service. In the scenario when an WPS service subscriber roams into a hybrid network implemented with a hybrid HLR 1202 the MSC/VLR 1201 communicates a UL message 1204 designating hybrid service to the hybrid HLR 1202. An ISD message 1206 designating the PrioritySubscriptioin parameter is communicated from the hybrid HLR 1202 to the MSC/VLR 1201. The MSC/VLR 1201 responds with an ISD-ack messge 1208. The hybrid HLR 1202 responds with a UL-ack message 1210. The MSC/VLR 1201 indicates that it supports the hybrid service in the UL. The HLR responds by sending priority service data (inc. PrioritySubscription parameter) in the ISD.

FIG. 13 displays a message flow diagram depicting a scenario when a WPS subscriber 1300 roams into a priority service network, that does not support the required priority service level/type. The priority service network is implemented with a hybrid HLR. In FIG. 13 an MSC/VLR is depicted as 1301. The MSC/VLR 1301 communicates with a hybrid HLR 1302. In one embodiment, the hybrid HLR 1302 represents an HLR storing subscriber information for an end user that has subscribed to a priority service. In the scenario when a WPS service subuscriber roams into a priority service network that does not support the the required priority service level/type the MSC/VLR 1301 communicates a UL message 1304 designating priority service to the hybrid HLR 1302. An ISD message 1306 designating no WPS is communicated from the hybrid HLR 1302 to the MSC/VLR 1301. The MSC/VLR 1301 responds with an ISD-ack messge 1308. The MSC/VLR 1301 indicates that it supports WPS Service. The HLR determines that the VLR does not support the required WPS service flavor and does not send any WPS data. The subscriber is treated as a normal subscriber.

FIG. 14 displays a message flow diagram depicting a scenario when a WPS subscriber roams into a hybrid service network, that does not support the required priority service level/type. The hybrid service network is implemented with a hybrid HLR. In FIG. 14 an MSC/VLR is depicted as 1401. The MSC/VLR 1401 communicates with a hybrid HLR 1402. In one embodiment, the hybrid HLR 1402 represents an HLR storing subscriber information for an end user that has subscribed to a WPS priority service. In the scenario when a WPS priority service subscriber roams into a priority service network that does not support the the required priority service level/type the MSC/VLR 1401 communicates a UL message 1404 designating WPS priority service to the hybrid HLR 1402. An ISD message 1406 designating no WPS is communicated from the hybrid HLR 1402 to the MSC/VLR 1401. The MSC/VLR 1401 responds with an ISD-ack messge 1408. The MSC/VLR 1401 indicates that it supports WPS Priority Service. The HLR determines that the VLR does not support the required priority service flavour and does not send any WPS data. The subscriber is treated as a normal subscriber.

The foregoing roaming scenarios are summarized in the Table given below.

TABLE 7
eMLPP User Roaming Scenarios

| | UL | | |
|---|---|---|---|
| | (priorityService- | | |
| MSC/VLR | Capability | | |
| capability | parameter) | ISD | Comments |
| EMLPP only | Parameter | EMLPP- | UL does not |
| | Not | INFO | contain the |
| | Included | parameter | priority |
| | | | service- |
| | | | capability |
| | | | parameter, |
| | | | indicating to the |
| | | | HLR that |
| | | | the MSC/VLR |
| | | | does not support |
| | | | the priority |
| | | | service or |
| | | | hybrid service. The |
| | | | HLR sends |
| | | | the subscribers |
| | | | EMLPP |
| | | | profile |
| | | | and check the |
| | | | ISD-ack to |
| | | | ascertain |
| | | | whether |
| | | | the MSC/VLR |
| | | | supports |
| | | | EMLPP or not. |
| Priority | priorityService | No | UL contains |
| Service | | EMLPP- | the priority |
| only | | Info sent. | service- |
| | | | Capability |
| | | | parameter, indicating |
| | | | to the |
| | | | HLR that the |
| | | | MSC/VLR only |
| | | | supports the |
| | | | priority service. |
| | | | The HLR does |
| | | | not send the |
| | | | subscribers |
| | | | EMLPP profile. |
| Hybrid | HybridService | EMLPP- | UL contains |
| | | INFO | the priority |
| | | parameter | service-Capability |
| | | | parameter, with |
| | | | the Hybrid |
| | | | service tag, |
| | | | indicating |
| | | | to the |
| | | | HLR that |
| | | | the MSC/VLR |
| | | | does support |
| | | | the hybrid |
| | | | services. |
| | | | The HLR |
| | | | sends the |
| | | | subscribers |
| | | | EMLPP profile. |

The foregoing roaming scenarios are summarized in the Table given below.

TABLE 8
Priority Service user Roaming Scenarios

| | UL | | |
|---|---|---|---|
| | (priorityService- | | |
| MSC/VLR | Capability | | |
| capability | parameter) | ISD | Comments |
| EMLPP | Parameter | No EMLPP- | UL does not |
| only | Not | Info sent. | contain the |
| | Included | | priority |
| | | | service- |
| | | | capability |
| | | | parameter, |
| | | | indicating |
| | | | to the |
| | | | HLR that |
| | | | the MSC/VLR |
| | | | does not |
| | | | support the |
| | | | priority/hybrid |
| | | | service. The |
| | | | HLR does not |
| | | | send the |
| | | | subscribers |
| | | | priority service |
| | | | profile. |
| Priority | priorityService | EMLPP- | UL contains |
| Service | | INFO | the priority |
| only | | parameter, | service- |
| | | containing the | capability |
| | | psSub | parameter, |
| | | parameter | indicating to |
| | | | the HLR |
| | | | that the |
| | | | MSC/VLR does |
| | | | supports the |
| | | | priority service. |
| | | | The HLR |
| | | | sends the |
| | | | subscribers |
| | | | priority |
| | | | service |
| | | | profile. |
| Hybrid | hybridService | EMLPP- | UL contains |
| | | INFO | the priority |
| | | parameter, | service- |
| | | containing the | Capability |
| | | psSub | parameter, |
| | | parameter | with the |
| | | | Hybrid |
| | | | service tag, |
| | | | indicating to |
| | | | the HLR that |
| | | | the |
| | | | MSC/VLR |
| | | | does support |
| | | | hybrid |
| | | | services. |
| | | | The HLR |
| | | | sends the |
| | | | subscribers WPS |
| | | | profile. |

The foregoing roaming scenarios are summarized in the Table given below. While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The foregoing roaming scenarios are summarized in the Table given below. It is, therefore, intended by the appended claims to cover any and all such applications, modifications, and embodiments within the scope of the present invention.

What is claimed is:

1. A method of operating comprising the steps of:
receiving a code; and
distinguishing different telecommunication services in response to receiving the code.

2. A method of operating as set forth in claim 1, wherein the code is a supplementary code.

3. A method of operating as set forth in claim 1 wherein the telecommunication services are priority services.

4. A method of operating a switch as set forth in claim 3, wherein at least one of the priority services includes a priority services capability parameter.

5. A method of operating as switch as set forth in claim 3, wherein at least one of the priority services is an eMLPP service.

6. A method of operating as switch as set forth in claim 3, wherein at least one of the priority services is a WPS service.

7. A method of operating as switch as set forth in claim 3, wherein at least one of the priority services is a hybrid service.

8. A method of operating comprising the steps of:
generating a UL message including a priority services designation;
receiving an ISD message in response to generating the UL message;
generating an ISD-ack message in response to receiving the ISD message; and
receiving a UL-ack message in response to generating the ISD-ack message.

9. A method of operating as set forth in claim 8, the UL message including eMLPP information.

10. A method of operating as set forth in claim 8, the UL message including WPS information.

11. A method of operating as set forth in claim 8, the UL message including hybrid service information.

12. A method of operating as set forth in claim 8, the ISD message including eMLPP information.

13. A method of operating as set forth in claim 8, the ISD message including WPS information.

14. A method of operating as set forth in claim 8, the ISD message including hybrid service information.

15. A method of operating comprising the steps of:
receiving a UL message including a priority services designation;
generating an ISD message in response to receiving the UL message;
receiving an ISD-ack message in response to generating the ISD message; and
generating a UL-ack message in response to receiving the ISD-ack message.

16. A method of operating as set forth in claim 15, the UL message including eMLPP information.

17. A method of operating as set forth in claim 15, the UL message including WPS information.

18. A method of operating as set forth in claim 15, the UL message including hybrid service information.

19. A method of operating as set forth in claim 15, the ISD message including eMLPP information.

20. A method of operating as set forth in claim 15, the ISD message including WPS information.
